(19) United States
(12) Patent Application Publication
(10) Pub. No.: US 2022/0335787 A1
(43) Pub. Date: Oct. 20, 2022

(54) GAMING MACHINE AND METHOD WITH FIXED ENHANCEMENT POSITIONS IN SYMBOL ARRAY

(71) Applicant: SG Gaming, Inc., Las Vegas, NV (US)

(72) Inventor: Jeremy HORNIK, Chicago, IL (US)

(21) Appl. No.: 17/554,230

(22) Filed: Dec. 17, 2021

Related U.S. Application Data
(60) Provisional application No. 63/174,654, filed on Apr. 14, 2021.

(51) Int. Cl. G07F 17/32; G07F 17/34

(52) U.S. Cl. CPC G07F 17/3267; G07F 17/3213; G07F 17/3209; G07F 17/34

(57) ABSTRACT

A gaming system and method utilize an electronic display device configured to display a symbol array with activatable enhancement positions. The activatable positions are fixed at their respective positions in the array and are fixedly associated with respective enhancement types. The system randomly activates a subset of the activatable positions and directs the display device to display indicators identifying the enhancements at their respective activated positions. A plurality of symbol-bearing reels are spun and stopped to land symbols on the reels in the symbol positions of the array. In response to a winning combination of the landed symbols passing through an activated enhancement position(s), the system provides an award for the winning combination enhanced by the activated enhancement associated with the activated position(s) through which the winning combination passes.

### CROSS REFERENCE TO RELATED APPLICATIONS

This application claims the benefit of priority to U.S. Provisional Application No. 63/174,654, filed Apr. 14, 2021, the contents of which are incorporated by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2021, SG Gaming, Inc.

### FIELD OF THE INVENTION

The present invention relates to a technological improvement to gaming systems, gaming machines, and methods and, more particularly, to new and improved animations in connection with a symbol array including fixed enhancement positions bearing different enhancement types.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present invention, there is provided a gaming system, gaming machine, and method that utilize an electronic display device configured to display, an array of symbol positions including a subset of activatable enhancement positions. The activatable enhancement positions are fixed at their respective positions in the array and are fixedly associated with respective enhancement types that remain the same from play to play of the wagering game. The enhancement types include at least three different types of enhancements. Game-logic, circuitry is configured to randomly activate a subset of the activatable enhancement positions to activate their respective enhancements. The subset of activated enhancement positions is less than all of the activatable enhancement positions. The game-logic circuitry directs the electronic display device to display indicators identifying the activated enhancements at their respective activated enhancement positions. A plurality of symbol-bearing reels are spun and stopped to land symbols on the reels in the symbol positions of the array. In response to a winning combination of the landed symbols passing through at least one of the activated enhancement positions, the game-logic circuitry is configured to provide an award for the winning combination enhanced by the activated enhancement associated with the at least one of the activated enhancement positions through which the winning combination passes.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is a flowchart for an algorithm that corresponds to instructions executed by a controller, according to an embodiment of the present invention.

FIG. 4 is a symbol array depicting the activatable enhancement positions bearing different enhancement types, including a payout multiplier, a wild activator, a free spin activator, and a lock-and-respin activator.

FIGS. 5 through 7 are symbol arrays depicting different subsets of activated enhancement positions while the reels are spun.

FIGS. 8 and 9 are symbol arrays illustrating the functionality of the payout multiplier enhancement type.

FIGS. 10 and 11 are symbol arrays illustrating the functionality of the wild activator enhancement type.

FIG. 12 is a symbol array illustrating the functionality of the free spin activator enhancement type.

FIGS. 13 and 14 are symbol arrays illustrating the functionality of the lock-and-respin activator enhancement type.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”, the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

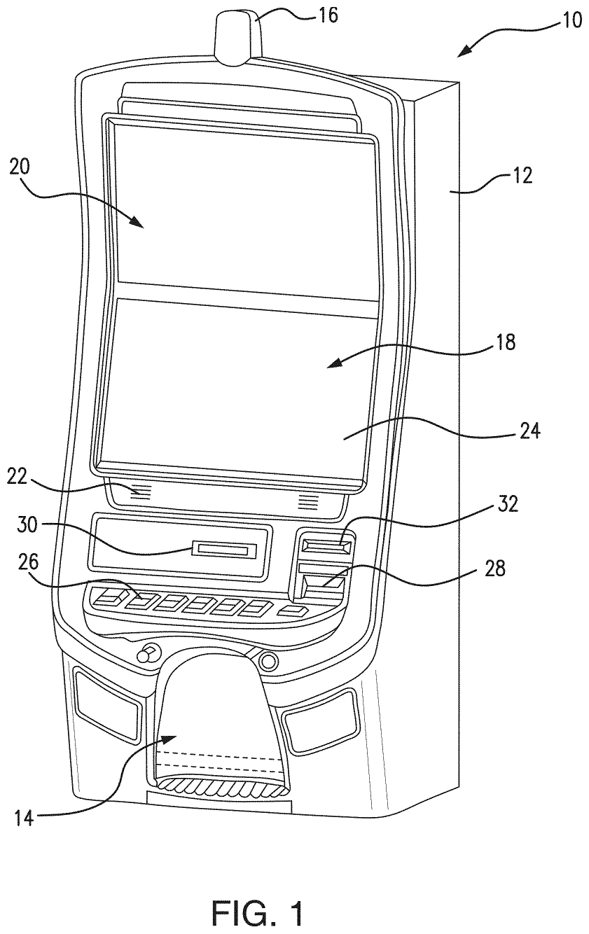

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

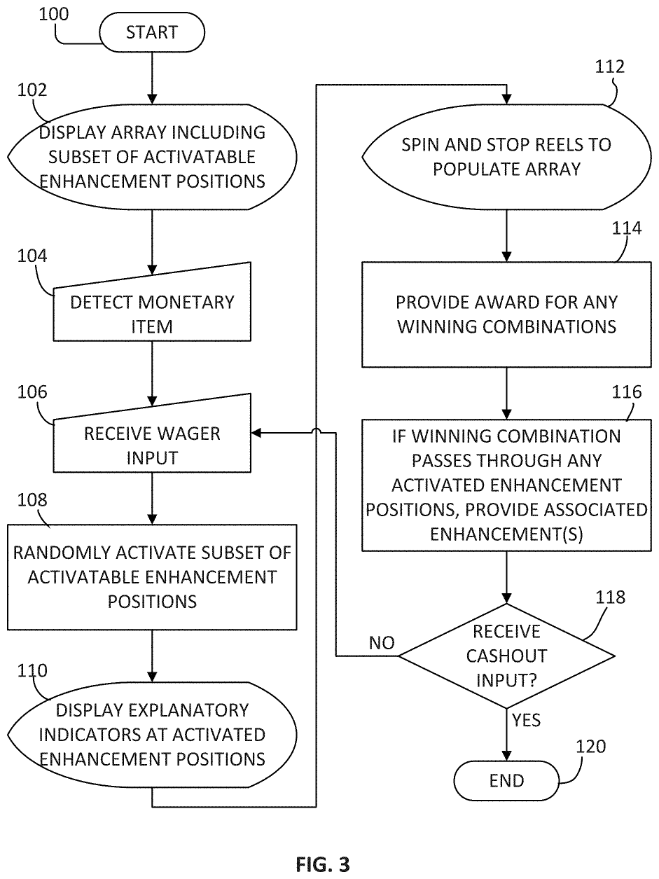

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

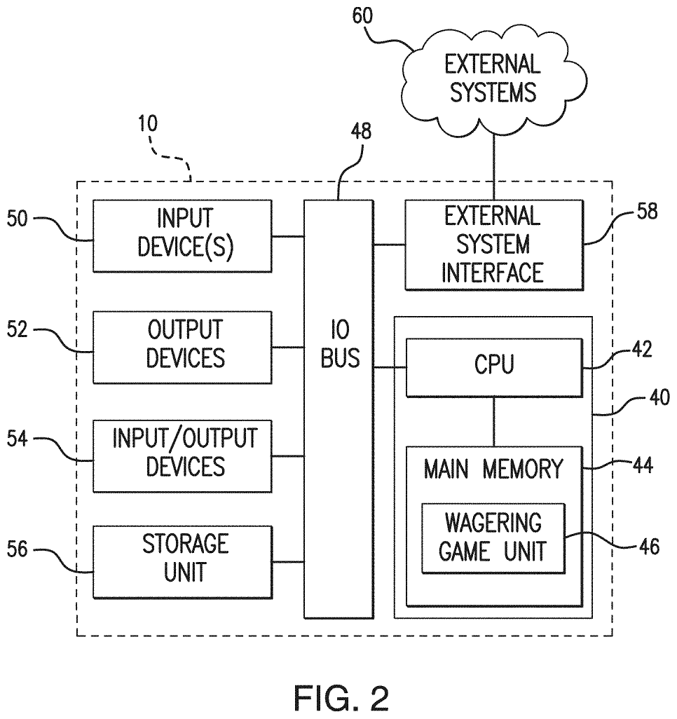

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

Referring now to FIG. 3, there is shown a flowchart representing one data processing method corresponding to at least some instructions stored and executed by the game-logic circuitry 40 in FIG. 2 to perform operations embodying the present invention.

At step 100, the game-logic circuitry starts a new game session at a gaming machine such as the machine 10 in FIG. 1.

At step 102, the game-logic circuitry directs an electronic display device (e.g., display 18 in FIG. 1) of the gaming machine to display an array of symbol positions including a subset of activatable enhancement positions. The enhancement positions are fixedly associated with respective enhancement types that remain the same from play to play (i.e., game cycle to game cycle) of the wagering game. Because the activatable enhancement positions and associated enhancement types always appear in the same places in the array, a player who is familiar with the game can instinctively understand the potential of what can be activated and where. The enhancement types include at least three different types of enhancements.

In one embodiment, the array of symbol positions is a 3×5 array of fifteen symbol positions arranged in three rows and five columns. In another embodiment, the array is a 4×6 array of twenty-four symbol positions arranged in four rows and 6 columns. In a 3×5 array containing first, second, third, fourth, and fifth columns from left to right, the subset of activatable enhancement positions is selected from a group consisting of: the first, second, and third columns; the second, third, and fourth columns; the third, fourth, and fifth columns; the first, third, and fifth columns; the second and fourth columns; and the middle row of five symbol positions. The subset of enhancement positions is preferably less than all of the symbol positions of the array but may, alternatively, be all of the symbol positions of the array. In one embodiment, the subset of activatable enhancement positions includes at least five symbol positions and, preferably, consists of the nine symbol positions in the second, third, and fourth columns.

In the embodiment shown in FIG. 4, a 3×5 symbol array 400 of fifteen symbol positions depicts a subset of nine activatable enhancement positions 402a through 402i bearing four different enhancement types, including a payout multiplier 404, a wild activator 406 (“Make Wild”), a free spin activator 408 (“10 Free Spins”), and a lock-and-respin activator 410 (“Lock & Respin”). The payout multiplier 404 includes three different multiplier values, including two 2× pays, two 3× pays, and two 5× pays. The activatable enhancement positions 402a-i occupy the second, third, and fourth columns of the array 400. The activatable enhancement positions and their associated enhancement types remain fixed at their symbol positions in the array 400 from play to play of the wagering game. In other words, the payout multiplier 404 always occupies the six positions 402a-c and 402g-i in the second and fourth columns of the array 400; the wild activator 406 always occupies the middle position 402e of the third column; the free spin activator 408 always occupies the bottom position 402f of the third column; and the lock-and-respin activator 410 always occupies the top position 402d of the third column. In one embodiment, although the payout multiplier always occupies the six positions 402a-c and 402g-i in the second and fourth columns, the values of the payout multiplier may randomly vary from play to play of the wagering game. Alternatively, the multiplier values may stay in the same place in the array from play to play of the wagering game such that, for example, the 2× pays always appear in the top position 402a of the second column and the bottom position 402i of the fourth column, the 3× pays always appear in the bottom position 402c of the second column and the top position 402g of the fourth column, and the 5× pays always appear in the middle positions 402b and 402h of the second and fourth columns. Similarly, the number of free spins associated with the free spin activator 408 may randomly vary or stay the same from play to play of the wagering game.

Returning to FIG. 3, at step 104, the game-logic circuitry detects, via a value input device, a physical item associated with a monetary value that establishes a credit balance on a credit meter. The value input device may, for example, be a bill acceptor, ticket acceptor, card reader, or coin acceptor as described above.

At step 106, the game-logic circuitry receives, via a player input device, an input indicative of a wager covered by the credit balance and initiates a game cycle. The player input device may, for example, be a push-button panel or a touch screen in front of the electronic display device.

At step 108, the game-logic circuitry randomly activates, using a random number generator (RNG) described above, a subset of the activatable enhancement positions to activate their respective enhancements. The subset of activated enhancement positions is less than all of the activatable enhancement positions. In one embodiment, if the subset of activatable enhancement positions consists of the nine symbol positions in the second, third, and fourth columns, the subset of activated enhancement positions includes up to three symbol positions. For example, two to three enhancement positions may be randomly selected and activated. In other embodiments, the maximum number of activated positions may be greater than three, e.g., four or five positions. The activated enhancement positions are shown with new and improved animations such as applying a border, pattern, color change, background change, watermark, or other characteristic that distinguishes the activated enhancement positions from the remaining symbol positions.

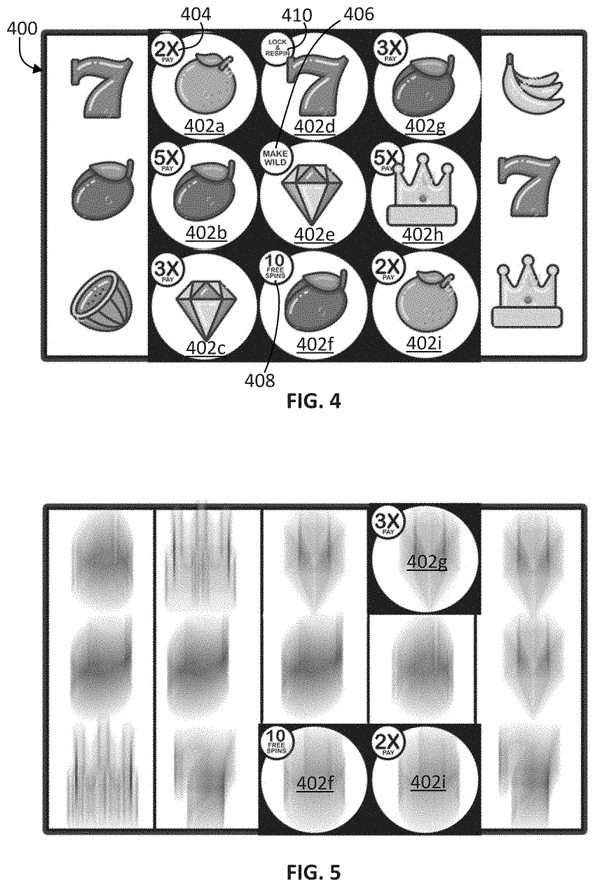

At step 110, the game-logic circuitry directs the electronic display device to show new and improved animations for displaying indicators (icons) identifying the activated enhancements at their respective activated enhancement positions. The indicators may, for example, be shown in an upper left corner of the activated enhancement positions and include explanatory/informational text describing the enhancement. For example, FIG. 5 depicts a subset of three activated enhancement positions 402f, 402g, and 402i bearing indicators of respective enhancements 10 Free Spins, 3× pay, and 2× pay for one play of the wagering game. FIG. 6 depicts a subset of two activated enhancement positions 402c and 402h bearing respective enhancements 3× pay and 5× pay for another play of the wagering game. FIG. 7 depicts a subset of three activated enhancement positions 402a, 402b, and 402d bearing respective enhancements 2× pay, 5× pay, and Lock & Respin for yet another play of the wagering game.

Returning to FIG. 3, at step 112, the game-logic circuitry spins and stops a plurality of symbol-bearing reels to land symbols on the reels in the symbol positions of the array. The reel spin is animated by depicting symbol-bearing strips moving vertically across the display and synchronously updating the symbols visible on each strip as the strip moves across the display. As shown in FIGS. 5-7, the activated enhancements are preferably displayed via their indicators prior to or while the reels are spinning (i.e., before the reels stop) to create a sense of anticipation and indicate the potential enhancements that may be applied when the reels stop. Some have low potential (see FIG. 6), while others are more interesting (see FIG. 7). As noted above, the game-logic circuitry generates a random game outcome using the above-referenced RNG, and then spins and stops the reels according to the selected game outcome. In one embodiment, an independent reel is associated with each respective symbol position of the array so that each stopped reel populates only that reel's associated symbol position. In another embodiment, each reel is associated with a respective column of the array so that each stopped reel populates the symbol positions in that reel's associated column.

At step 114, the game-logic circuitry provides a payout/award for any winning combinations of the landed symbols. For example, winning combinations may be left-to-right “Anyways” pays comprising three, four, or five matching symbols in adjacent columns starting from the leftmost column, “line” pays comprising predefined winning combinations along predefined patterns of symbol positions, or “scatter” pays comprising a number of matching symbols appearing anywhere in the array. For purposes of the examples in FIGS. 4-14, winning combinations are limited to “Anyways” pays. To communicate the awards and winning symbol combinations to the player, the game-logic circuitry directs the display to animate the symbols in each winning combination, the way or line along which each winning combination appears, and the award amount. The animation may, for example, include applying a border, pattern, color change, background change, watermark, or other distinguishing characteristic to the winning symbols and/or winning symbol positions.

At step 116, if the winning combination passes through (contains) any activated enhancement positions, the game-logic circuitry awards the enhancement(s) associated with the enhancement positions through which the winning combination passes. A single winning combination may pass through multiple enhancement positions. Different winning combinations may pass through the same enhancement position(s), different enhancement positions, or the same enhancement position(s) in part and different enhancement positions in part.

As noted above, the enhancement types include at least three different types of enhancements. In one embodiment, there are four types of enhancements, including a payout multiplier, a wild activator (“Make Wild”), a free spin activator (“Free Spins”), and a lock-and-respin activator (“Lock & Respin”). If a winning combination passes through an activated enhancement position bearing the payout multiplier, the standard payout for that combination is multiplied by the payout multiplier. The multiplier value may, for example, be 2×, 3×, or 5×. If an activatable enhancement position is fixedly associated with a payout multiplier, the associated multiplier value may always be the same (e.g., always 3×) for that enhancement position or may be randomly selected from play to play of the wagering game. If a winning combination passes through multiple activated enhancement positions bearing respective payout multipliers, the standard payout for that combination is multiplied by the product of the payout multipliers. Alternatively, the standard payout may be multiplied by the sum of the payout multipliers.

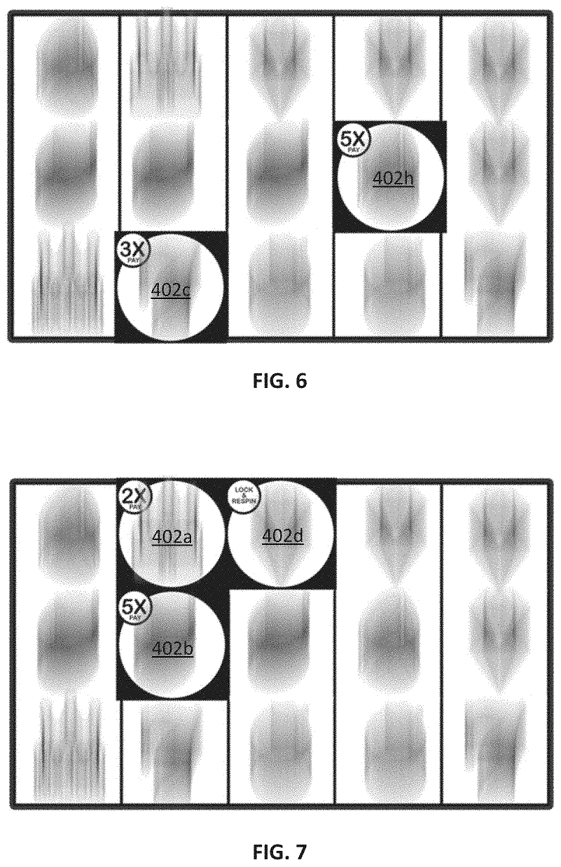

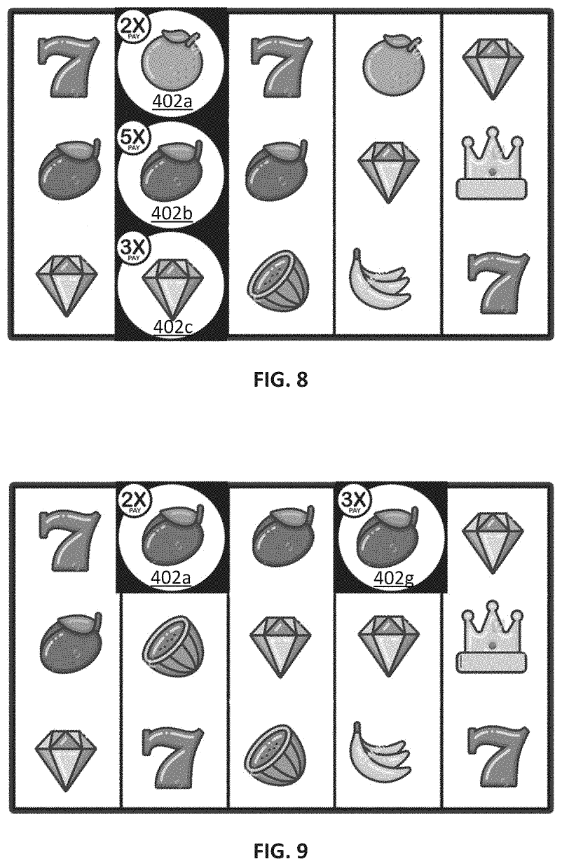

FIGS. 8 and 9 are symbol arrays illustrating the functionality of the payout multiplier enhancement type. In FIG. 8, the activated enhancement positions 402a, 402b, and 402c bear respective payout multipliers 2× pay, 5× pay, and 3× pay. A winning combination of three PLUM symbols passes through the activated enhancement position 402b bearing 5× pay. Accordingly, the standard payout for this winning combination is multiplied by 5×. In FIG. 9, the activated enhancement positions 402a and 402g bear respective payout multipliers 2× pay and 3× pay. A winning combination of four PLUM symbols passes through both activated positions. Accordingly, the standard payout for this winning combination is multiplied by the product of the two associated multiplier values, or 6×=2×*3×. In an alternative embodiment, instead of the product, the standard payout is multiplied by the sum of the multiplier values, or 5×=2×+3×.

If a winning combination passes through an activated enhancement position bearing the wild activator, then the symbol in that enhancement position as well as any matching/like symbols elsewhere in the array are transformed into wild symbols. A wild symbol may, for example, substitute for any standard symbols in the wagering game. Once the symbols are transformed into wild symbols, the game-logic circuitry provides payouts for any additional winning combinations caused by the wild symbols. It should be noted that a symbol in an activated enhancement position (as well as any matching symbols elsewhere in the array) only transforms into a wild if a winning combination passes through that enhancement position prior to the wild transformation.

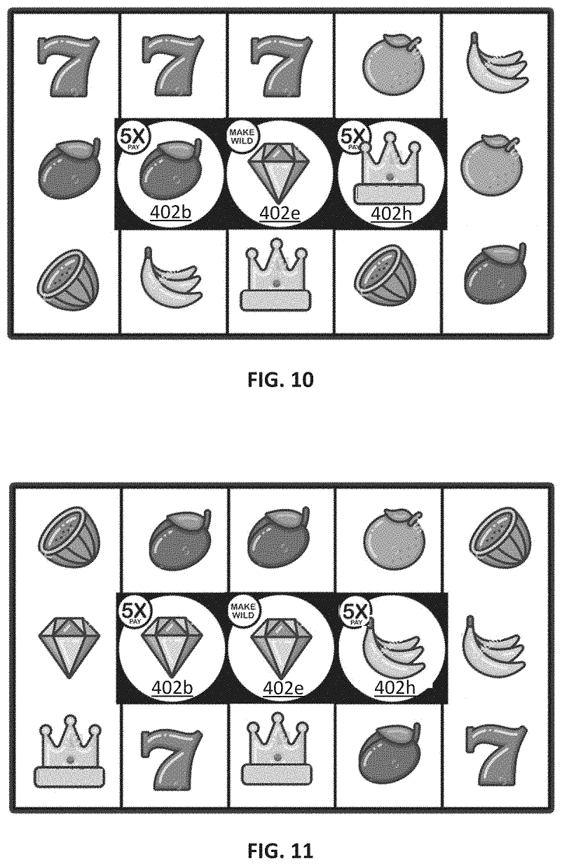

FIGS. 10 and 11 are symbol arrays illustrating the functionality of the wild activator enhancement type. The activated enhancement positions 402b, 402e, and 402h bear respective enhancements 5× pay, a wild activator (“Make Wild”), and 5× pay. In FIG. 10, no winning combinations passes through any of the activated enhancement positions and, therefore, the DIAMOND symbol in enhancement position 402e does not transform into a wild symbol. The winning combination of three SEVEN symbols yields a standard payout. In FIG. 11, however, a winning combination of three DIAMOND symbols passes through the activated enhancement positions 402b and 402e. Accordingly, the standard payout for this winning combination is multiplied by the 5× multiplier value in activated position 402b. Additionally, because the DIAMOND symbol in activated “Make Wild” position 402e is in a winning combination, that DIAMOND symbol as well as all other DIAMOND symbols in the array are transformed into wild symbols, leading to a plethora of other winning combinations including three SEVEN, 4× four PLUM (i.e., four different winning combinations of four PLUM), three MELON, four ORANGE, five BANANA, and 3× three CROWN.

If a winning combination passes through an activated enhancement position bearing the free spin activator, the free spin activator provides a plurality of free spins of the reels. When the free spins are awarded, any other activated enhancement positions remain activated for the duration of the free spins.

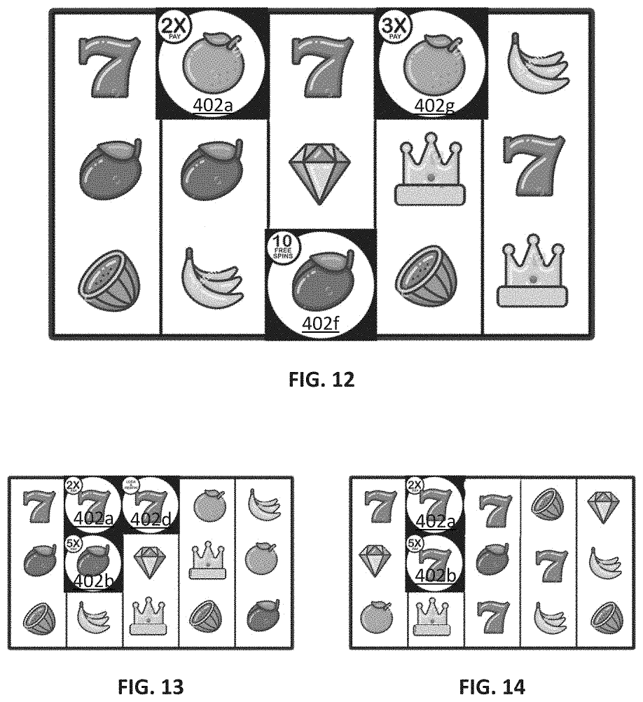

FIG. 12 is a symbol array illustrating the functionality of the free spin activator enhancement type. The activated enhancement positions 402a, 402f, and 402g bear respective enhancements 2× pay, a free spin activator (“10 Free Spins”), and 3× pay. A winning combination of three PLUM symbols passes through the activated enhancement position 402f bearing 10 Free Spins. Accordingly, after awarding the standard payout for this winning combination, the player is awarded ten free spins (free games) of the reels with the other enhancement positions 402a and 402g remaining activated for the duration of the free spins.

If a winning combination passes through an activated enhancement position bearing the lock-and-respin activator, the winning combination is held in place while the remaining reels are respun and stopped to re-populate remaining ones of the symbol positions and potentially improve the winning combination or produce other winning combinations. Any other activated enhancement positions remain activated for the respin.

FIGS. 13 and 14 are symbol arrays illustrating the functionality of the lock-and-respin activator enhancement type. In FIG. 13, the activated enhancement positions 402a, 402b, and 402d bear respective enhancements 2× pay, 5× pay, and a lock-and-respin activator (“Lock & Respin”). A winning combination of three SEVEN symbols passes through the activated enhancement positions 402a and 402d. Accordingly, the standard payout for this winning combination is multiplied by 2×. Additionally, because the SEVEN symbol in activated “Lock & Respin” position 402d is in the winning combination of three SEVEN symbols, the three SEVEN symbols are held in place while the remaining reels are respun once and stopped to re-populate remaining ones of the symbol positions and potentially improve the winning combination or produce other winning combinations. Any other activated enhancement positions (i.e., positions 402a and 402b) remain activated for the respin. In FIG. 14, the respin results in 4× four SEVEN (i.e., four different winning combinations of four SEVEN symbols).

Returning to FIG. 3, at step 118, the game-logic circuitry either returns to step 106 for a new game cycle, or receives, via the player input device, a cashout input that initiates a payout from the credit balance on the credit meter, thereby ending the game session at step 120.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine to play a wagering game, the method comprising the operations of:
displaying, on an electronic display device, an array of symbol positions including a subset of activatable enhancement positions, the activatable enhancement positions being fixedly associated with respective enhancement types, the activatable enhancement positions remaining fixed at their respective symbol positions in the array from play to play of the wagering game, the enhancement types including at least three different types of enhancements;
randomly activating a subset of the activatable enhancement positions to activate their respective enhancements, the subset of activated enhancement positions being less than all of the activatable enhancement positions;
displaying, on the electronic display device, indicators identifying the activated enhancements at their respective activated enhancement positions;
spinning and stopping a plurality of symbol-bearing reels to land symbols on the reels in the symbol positions of the array; and
in response to a winning combination of the landed symbols passing through at least one of the activated enhancement positions, providing, by game-logic circuitry, an award for the winning combination enhanced by the activated enhancement associated with the at least one of the activated enhancement positions through which the winning combination passes.

2. The method of claim 1, wherein the array of symbol positions includes at least fifteen symbol positions, and wherein the subset of activatable enhancement positions includes at least five symbol positions.

3. The method of claim 1, wherein the array of symbol positions includes at least three rows and five columns, the five columns including first, second, third, fourth, and fifth columns from left to right, and wherein the subset of activatable enhancement positions is selected from a group consisting of: the first, second, and third columns; the second, third, and fourth columns; the third, fourth, and fifth columns; the first, third, and fifth columns; the second and fourth columns; and one of the rows.

4. The method of claim 2, wherein the subset of activated enhancement positions includes up to three symbol positions.

5. The method of claim 1, wherein the subset of activatable enhancement positions is less than all of the symbol positions of the array.

6. The method of claim 1, wherein the three different types of enhancements are selected from a group consisting of a payout multiplier, a wild activator, a free spin activator, and a lock-and-respin activator, the payout multiplier multiplying the award by the payout multiplier, the wild activator causing any landed symbols that match the symbol in the at least one of the activated enhancement positions to become wild, the free spin activator providing a plurality of free spins of the reels, the lock-and-respin activator causing the winning combination to be held in place while the reels are respun and stopped to re-populate remaining ones of the symbol positions.

7. The method of claim 1, wherein the reels are associated with the respective symbol positions of the array, and wherein the spinning and stopping operation causes each reel to land a symbol on the reel in that reel's respective symbol position.

8. The method of claim 1, further comprising the operations of:
detecting, via a value input device, a physical item associated with a monetary value that establishes a credit balance on a credit meter;
receiving, via a player input device, an input indicative of a wager covered by the credit balance; and
receiving, via the player input device, a cashout input that initiates a payout from the credit balance on the credit meter.

9. A gaming system to play a wagering game, comprising:
a gaming machine including an electronic display device configured to display an array of symbol positions including a subset of activatable enhancement positions, the activatable enhancement positions being fixedly associated with respective enhancement types, the activatable enhancement positions remaining fixed at their respective symbol positions in the array from play to play of the wagering game, the enhancement types including at least three different types of enhancements; and
game-logic circuitry configured to perform the operations of:
randomly activating a subset of the activatable enhancement positions to activate their respective enhancements, the subset of activated enhancement positions being less than all of the activatable enhancement positions;
directing the electronic display device to display indicators identifying the activated enhancements at their respective activated enhancement positions;
spinning and stopping a plurality of symbol-bearing reels to land symbols on the reels in the symbol positions of the array; and
in response to a winning combination of the landed symbols passing through at least one of the activated enhancement positions, providing an award for the winning combination enhanced by the activated enhancement associated with the at least one of the activated enhancement positions through which the winning combination passes.

10. The system of claim 9, wherein the array of symbol positions includes at least fifteen symbol positions, and wherein the subset of activatable enhancement positions includes at least five symbol positions.

11. The system of claim 9, wherein the array of symbol positions includes at least three rows and five columns, the five columns including first, second, third, fourth, and fifth columns from left to right, and wherein the subset of activatable enhancement positions is selected from a group consisting of: the first, second, and third columns; the second, third, and fourth columns; the third, fourth, and fifth columns; the first, third, and fifth columns; the second and fourth columns; and one of the rows.

12. The system of claim 10, wherein the subset of activated enhancement positions includes up to three symbol positions.

13. The system of claim 9, wherein the subset of activatable enhancement positions is less than all of the symbol positions of the array.

14. The system of claim 9, wherein the three different types of enhancements are selected from a group consisting of a payout multiplier, a wild activator, a free spin activator, and a lock-and-respin activator, the payout multiplier multiplying the award by the payout multiplier, the wild activator causing any landed symbols that match the symbol in the at least one of the activated enhancement positions to become wild, the free spin activator providing a plurality of free spins of the reels, the lock-and-respin activator causing the winning combination to be held in place while the reels are respun and stopped to re-populate remaining ones of the symbol positions.

15. The system of claim 9, wherein the reels are associated with the respective symbol positions of the array, and wherein the spinning and stopping operation causes each reel to land a symbol on the reel in that reel's respective symbol position.

16. The system of claim 9, wherein the gaming machine includes a value input device and a player input device, the value input device configured to detect a physical item associated with a monetary value that establishes a credit balance on a credit meter, the player input device configured to receive an input indicative of a wager covered by the credit balance and to receive a cashout input that initiates a payout from the credit balance on the credit meter.

17. A gaming machine to play a wagering game, comprising:
an electronic display device configured to display an array of symbol positions including a subset of activatable enhancement positions, the subset of activatable enhancement positions being less than all of the symbol positions of the array, the activatable enhancement positions being fixedly associated with respective enhancement types, the activatable enhancement positions remaining fixed at their respective symbol positions in the array from play to play of the wagering game, the enhancement types including at least three different types of enhancements;
a value input device configured to detect a physical item associated with a monetary value that establishes a credit balance on a credit meter;
a player input device configured to receive an input indicative of a wager covered by the credit balance and to receive a cashout input that initiates a payout from the credit balance on the credit meter; and
game-logic circuitry configured to perform the operations of:
randomly activating a subset of the activatable enhancement positions to activate their respective enhancements, the subset of activated enhancement positions being less than all of the activatable enhancement positions;
directing the electronic display device to display indicators identifying the activated enhancements at their respective activated enhancement positions;
spinning and stopping a plurality of symbol-bearing reels to land symbols on the reels in the symbol positions of the array; and
in response to a winning combination of the landed symbols passing through at least one of the activated enhancement positions, providing an award for the winning combination enhanced by the activated enhancement associated with the at least one of the activated enhancement positions through which the winning combination passes.

18. The machine of claim 17, wherein the array of symbol positions includes at least fifteen symbol positions, wherein the subset of activatable enhancement positions includes at least five symbol positions, and wherein the subset of activated enhancement positions includes up to three symbol positions.

19. The machine of claim 17, wherein the array of symbol positions includes at least five columns, and wherein the subset of activatable enhancement positions includes at least two of the columns.

20. The machine of claim 17, wherein the three different types of enhancements are selected from a group consisting of a payout multiplier, a wild activator, a free spin activator, and a lock-and-respin activator, the payout multiplier multiplying the award by the payout multiplier, the wild activator causing any landed symbols that match the symbol in the at least one of the activated enhancement positions to become wild, the free spin activator providing a plurality of free spins of the reels, the lock-and-respin activator causing the winning combination to be held in place while the reels are respun and stopped to re-populate remaining ones of the symbol positions.
